(19) United States
(12) Patent Application Publication
(10) Pub. No.: US 2018/0060013 A1
(43) Pub. Date: Mar. 1, 2018

(54) DISPLAY APPARATUS, MULTI-DISPLAY SYSTEM, AND METHOD FOR CONTROLLING THE DISPLAY APPARATUS

(71) Applicant: SAMSUNG ELECTRONICS CO., LTD., Suwon-si (KR)

(72) Inventors: Chang Won SON, Seoul (KR); Kun Sok KANG, Suwon-si (KR); Byung Seok SOH, Yongin-si (KR); Hyun A SONG, Suwon-si (KR); Kyung-Hoon LEE, Seoul (KR)

(73) Assignee: SAMSUNG ELECTRONICS CO., LTD., Suwon-si (KR)

(21) Appl. No.: 15/619,899

(22) Filed: Jun. 12, 2017

(30) Foreign Application Priority Data
Aug. 26, 2016 (KR) 10-2016-0109378

(51) Int. Cl. G06F 3/14

(52) U.S. Cl. CPC G06F 3/1446

(57) ABSTRACT

A display apparatus, a multi-display system, and a method for controlling the display apparatus are disclosed. The display apparatus includes a housing, at least one sensor mounted to a first boundary surface of the housing, and a display for displaying an image corresponding to a position of the display apparatus determined based on an electrical signal generated from the at least one sensor.

### CROSS-REFERENCE TO RELATED APPLICATION

This application claims priority from Korean Patent Application No. 10-2016-0109378, filed on Aug. 26, 2016 in the Korean Intellectual Property Office, the disclosure of which is incorporated herein by reference.

### BACKGROUND

### 1. Field

Apparatuses and methods consistent with example embodiments relate to a display apparatus and a method for controlling the same so as to reduce power consumption.

### 2. Description of the Related Art

A display apparatus is a device for representing an electrical signal as visual information and displaying the visual information to a user. For example, the display apparatus may include a television, a computer monitor, and various mobile terminals (e.g., a smartphone, etc.).

A plurality of display apparatuses may also be interconnected to communicate with each other through a cable or a wireless communication module as necessary. The interconnected display apparatuses may display the same or different images as necessary. If the display apparatuses display different images, images displayed on the respective display apparatuses may be associated with each other. For example, images displayed on the respective display apparatuses may be different parts of any one image.

### SUMMARY

One or more example embodiments provide a display apparatus, a multi-display system, and a method for controlling the display apparatus, which can determine a relative position of each display apparatus when a plurality of display apparatuses is combined to display one or more images, and can properly display some parts of the image corresponding to the determined position.

Additional aspects will be set forth in part in the description which follows and, in part, will be obvious from the description, or may be learned by practice.

According to an aspect of an example embodiment, there is provided a display apparatus including a housing; at least one sensor mounted to a first boundary surface of the housing; and a display configured to display an image corresponding to a position of the display apparatus determined based on an electrical signal generated from the at least one sensor.

The display apparatus may include a sensing target formed at a second boundary surface facing the first boundary surface.

The sensing target may be configured to be detected by at least one sensor of a second display apparatus.

The display apparatus may include a communicator configured to receive a sensing result obtained by the at least one sensor of the second display apparatus, wherein the display may be configured to display an image corresponding to the position of the display apparatus determined based on the sensing result that is received.

The sensing target may extend from a peripheral part of a first end of the second boundary surface to a peripheral part of a second end of the second boundary surface, and may be formed at the second boundary surface.

The sensing target may be formed at the second boundary surface in a predetermined pattern extending from a peripheral part of the first end of the second boundary surface to a peripheral part of the second end of the second boundary surface.

The sensing target may include a metal material, and the metal material may be formed at the second boundary surface and may be gradually reduced in width from a peripheral part of the first end of the second boundary surface to a peripheral part of the second end of the second boundary surface.

The sensing target may include a plurality of light sources, and a first light source, which is relatively adjacent to the peripheral part of the first end of the second boundary surface, from among the plurality of light sources, may emit brighter light than a second light source, which is relatively adjacent to the peripheral part of the second end of the second boundary surface.

The sensing target may include a plurality of light sources, wherein each of the plurality of light sources may emit a different brightness of light, and the plurality of light sources may be sequentially arranged, according to brightness, in a range from the peripheral part of the first end of the second boundary surface to the peripheral part of the second end of the second boundary surface.

The sensing target may include a plurality of light sources, and each of the plurality of light sources may emit a different wavelength of light.

The at least one sensor may be configured to detect a sensing target mounted to a second display apparatus.

The display apparatus may include a processor configured to determine a relative position between the second display apparatus and the display apparatus based on an electrical signal generated from the at least one sensor.

The processor may be further configured to determine a relative position between the second display apparatus and the display apparatus using a position of the at least one sensor that generated the electrical signal.

The processor may be configured to determine a relative position between the second display apparatus and the display apparatus based on a magnitude of the electrical signal generated from the at least one sensor.

The processor may be configured to determine an image to be displayed on the display based on a relative position of the display apparatus, control the relative position of the display apparatus to be transmitted to the second display apparatus, or determine an image to be displayed on the second display apparatus based on a relative position of the display apparatus, and transmit the image that is determined to be displayed on the second display apparatus to the second display apparatus.

The at least one sensor may include at least one from among an inductance sensor, an illumination sensor, and a color sensor.

The at least one sensor may be mounted to at least one from among a first end and a second end of the first boundary surface.

The at least one sensor may be mounted to a boundary surface orthogonal to the first boundary surface.

According to an aspect of another example embodiment, there is provided a multi-display system including: a first display apparatus including: a first housing; and a sensing target formed at a first boundary surface of the first housing; a second display apparatus including: a second housing; a second boundary surface formed in the second housing and mountable in contact with the first boundary surface; and a sensor mounted to the second boundary surface that outputs an electrical signal according to a sensing result of a first sensing target; and a display control device configured to: determine a relative position between the first display apparatus and the second display apparatus based on the electrical signal; and determine an image to be displayed on at least one from among the first display apparatus and the second display apparatus according to the relative position that is determined.

According to an aspect of another example embodiment, there is provided a method for controlling a plurality of display apparatuses, the method including: determining whether a first boundary surface of a first display apparatus and a second boundary surface of a second display apparatus approach each other; detecting, by a sensor mounted to the second boundary surface of the second display apparatus, a sensing target formed at the first boundary surface of the first display apparatus; outputting, by the sensor, an electrical signal corresponding to a sensing result of the sensing target; determining, by at least one from among the first display apparatus, the second display apparatus, and a control device connected to at least one of the first display apparatus and the second display apparatus, a relative position of at least one from among the first display apparatus and the second display apparatus based on the electrical signal; and determining, by at least one from among the first display apparatus, the second display apparatus, and a control device connected to at least one of the first display apparatus and the second display apparatus, an image to be displayed on at least one from among the first display apparatus and the second display apparatus according to a relative position between the first display apparatus and the second display apparatus.

### BRIEF DESCRIPTION OF THE DRAWINGS

These and/or other aspects will become apparent and more readily appreciated from the following description of the example embodiments, taken in conjunction with the accompanying drawings of which:

FIG. 1 is a perspective view illustrating a display apparatus according to an example embodiment.

FIG. 2 is a perspective view illustrating a display apparatus according to an example embodiment.

FIG. 3 is a side view illustrating the first boundary surface of the housing.

FIG. 4 is a view illustrating the sensing target mounted to the second boundary surface of the housing according to an example embodiment.

FIG. 5 is a view illustrating an example embodiment of the sensing target and the sensor of the second display apparatus.

FIG. 6 is a graph illustrating the magnitude of an output signal of the sensor of the second display apparatus.

FIG. 7 is a side view illustrating a modification example of the sensing target according to an example embodiment.

FIG. 8 is a view illustrating the sensing target mounted to the second boundary surface of the housing according to an example embodiment.

FIG. 9 is a view illustrating an example embodiment of the sensing target and the sensor of the second display apparatus.

FIG. 10 is a side view illustrating the sensing target mounted to the second boundary surface of the housing according to an example embodiment.

FIG. 11 is a view illustrating an example embodiment of the sensing target and the sensor of the second display apparatus.

FIG. 12 is a view illustrating the sensing target mounted to the second boundary surface of the housing according to an example embodiment.

FIG. 13 is a perspective view illustrating the multi-display system including two display apparatuses according to an example embodiment.

FIG. 14 is a block diagram illustrating the multi-display system including two display apparatuses according to an example embodiment.

FIG. 15 is a view illustrating an example in which the sensor of the second display apparatus outputs a signal based on the sensing result of the sensing target of the first display apparatus.

FIG. 16A is a view illustrating an example of images according to an example embodiment.

FIG. 16B is a view illustrating an example in which each display apparatus of the multi-display system displays images.

FIG. 17 is a perspective view illustrating a multi-display system including two display apparatuses according to an example embodiment.

FIG. 18 is a block diagram illustrating a multi-display system including two display apparatuses according to an example embodiment.

FIG. 19A is a first view illustrating an example embodiment of the multi-display system including a plurality of display apparatuses.

FIG. 19B is a second view illustrating an example embodiment of the multi-display system including a plurality of display apparatuses.

FIG. 20 is a view illustrating a display apparatus according to an example embodiment.

FIG. 21 is a flowchart illustrating a method for controlling the display apparatus.

### DETAILED DESCRIPTION

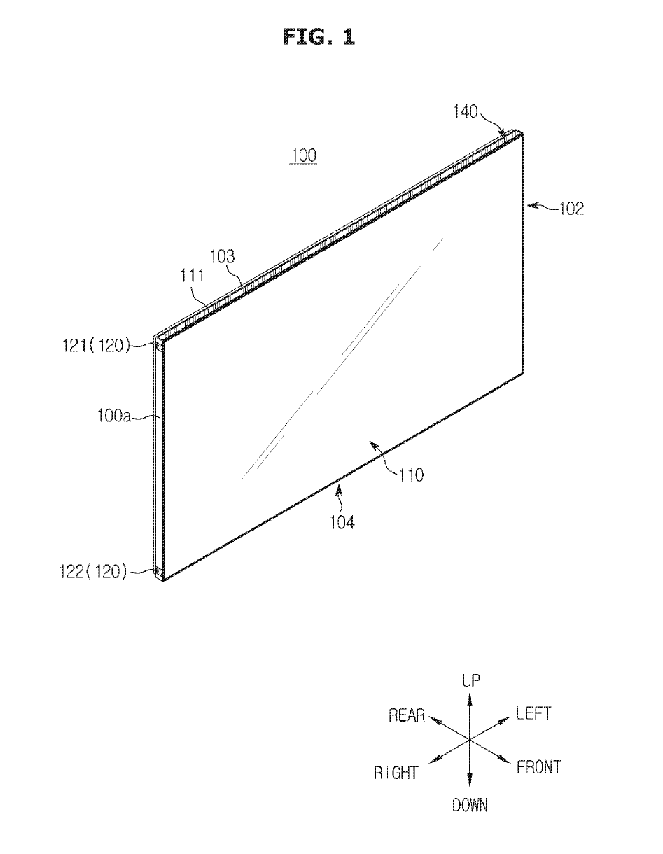

Reference will now be made in detail to example embodiments, which are illustrated in the accompanying drawings, wherein like reference numerals refer to like elements throughout. A display apparatus and a multi-display system including the same according to an example embodiment will hereinafter be described with reference to FIGS. 1 to 20.

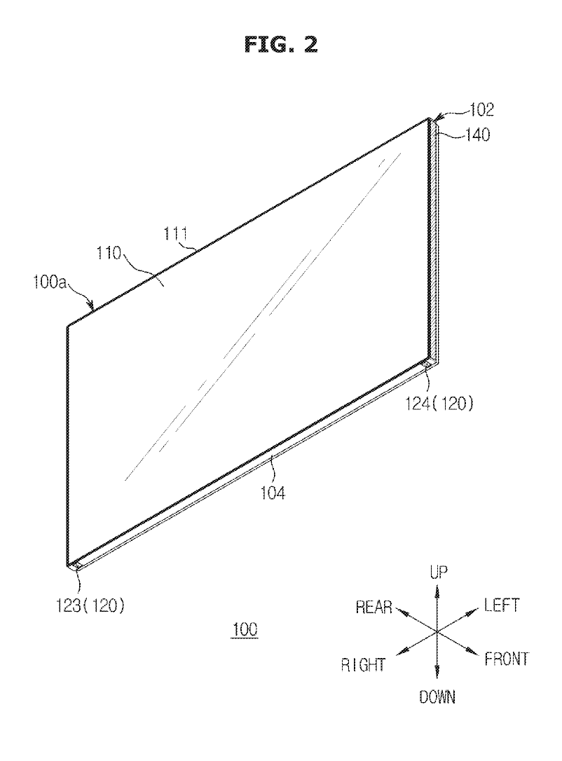

FIG. 1 is a perspective view illustrating a display apparatus according to an example embodiment. FIG. 2 is a perspective view illustrating a display apparatus according to an example embodiment.

The display apparatus 100 may be a device for displaying predetermined images, and may further output voice or sound signals as necessary. The display apparatus 100 may include a television, a smartphone, a cellular phone, a tablet PC, a monitor, a laptop, a navigation device, a portable gaming system, etc.

For convenience of description and better understanding, an example embodiment describes a display apparatus 100 is implemented as a television. However, the following constituent elements and functions are not limited only to the case in which the display apparatus 100 is implemented as a television, and may be equally applied to or be partially modified into the other case in which the display apparatus 100 is a smartphone or the like without departing from the scope or spirit of the present disclosure.

Referring to FIGS. 1 and 2, the display apparatus 100 may include a housing 100a for forming the external appearance of the display apparatus 100, and a display 110 mounted to the housing 100a so as to display one or more images thereon.

The housing 100a may include the display 110 fixed thereto, and may further include various constituent elements associated with various operations of the display apparatus 100. In more detail, an opening enclosed with a bezel 111 may be provided to the front of the housing 100a in such a manner that the display 110 can be installed in the opening and a rear frame 103 can be installed at the rear of the housing 100a. Various kinds of constituent elements for interconnecting the display 110 and the housing 100a may be installed to the inside of the bezel 111. In accordance with an example embodiment, the bezel 111 may be omitted as necessary. A wall-mounted frame may also be formed in a backward direction of the rear frame 103 in such a manner that the display apparatus 100 can be mounted to a wall or the like. In addition, a stand (e.g., a support) for supporting the display apparatus 100 may be formed in the housing 100a, and the stand may be mounted to a back surface of the rear frame 103 or a downward boundary surface 104 of the housing 100a. The stand may be omitted according to example embodiments.

A substrate, various semiconductor chips, circuits, etc. associated with the operation of the display apparatus 100 may be disposed in the housing 100a. In this case, although the substrate, the semiconductor chip, the circuit, etc. may be installed between the display 110 and the rear frame 103, may not be limited thereto, and may be installed at various positions of the housing 100a.

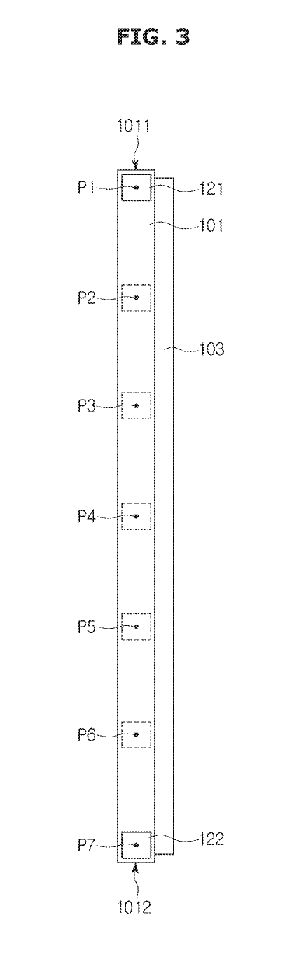

Referring to FIGS. 2 and 3, the housing 100a may be formed in a square shape, rectangular shape, trapezoidal shape, diamond shape, or the like as necessary. However, the shape of the housing 100a is not limited thereto, and the housing 100a may be formed in various shapes by the designer.

The housing 100a may include a plurality of boundary surfaces 101 to 104. A first boundary surface 101 from among the plurality of boundary surfaces 101 to 104 may be arranged to face the second boundary surface 102, and a third boundary surface 103 may be arranged to face the fourth boundary surface 104. In this case, the first boundary surface 101 and the second boundary surface 102 may be parallel to each other, and the third boundary surface 103 and the fourth boundary surface 104 may also be parallel to each other. If the housing 100a is formed in a square or rectangular shape, the first boundary surface 101 is orthogonal to the third boundary surface 103 and the fourth boundary surface 104, and the second boundary surface 102 is also orthogonal to the third boundary surface 103 and the fourth boundary surface 104. However, an included angle between the first boundary surface 101 and the third boundary surface 103, an included angle between the first boundary surface 101 and the fourth boundary surface 104, an included angle between the second boundary surface 102 and the third boundary surface 103, and an included angle between the second boundary surface 102 and the fourth boundary surface 104 are not limited only to a right angle, and may be used in various ways according to selection of the designer.

As can be seen from FIGS. 1 and 2, although the first boundary surface 101 and the second boundary surface 102 are respectively arranged at the left side and the right side of the display apparatus 100, and the third boundary surface 103 and the fourth boundary surface 104 are respectively arranged at an upper side and a lower side of the display apparatus 100 for convenience of description and better understanding, it should be noted that the first to fourth boundary surfaces 101 to 104 can be defined in various ways according to selection of the designer.

In accordance with an example embodiment, at least one sensor 120 may be mounted to at least one of the first boundary surface 101 and the fourth boundary surface 104. In this case, at least one sensor 120 may be mounted to at least one of both ends of the boundary surface 101, and/or may be mounted to at least one of both ends of the fourth boundary surface 104. The at least one sensor may sense a target object to be sensed, and may output a predetermined electrical signal corresponding to the sensing result. In this case, the at least one sensor 120 may be configured to sense a sensing target to be sensed for the other display apparatus as well as to output an electrical signal based on the sensing result. That is, the at least one sensor 120 may be used to correspond to the sensing target to be detected for the other display apparatus.

In more detail, the other display apparatus may be attached to or adjacent to the display apparatus 100, such that the boundary surface to which a sensing target of the other display apparatus 200 is mounted may be brought into contact with the first boundary surface 101 or may be located in close proximity to the first boundary surface 101. In this case, at least one sensor 120 of the display apparatus 100 may detect the sensing target of the other display apparatus, and may output an electrical signal corresponding to the sensing result.

In accordance with an example embodiment, the sensor 120 may include at least one of an inductance sensor, an illumination sensor, and a color sensor. The inductance sensor may be a sensor configured to output the electrical signal corresponding to inductance generated according to the shape of the sensing target. The illumination sensor may be a sensor, which is capable of detecting brightness of light to be emitted and then outputting an electrical signal corresponding to the detected brightness. For example, the illumination sensor may include a photodiode. The color sensor may be a sensor, which is capable of outputting an electrical signal corresponding to color of incident light. For example, the color sensor may include a photodiode in which an RGB sensor is installed. In addition, the sensor 120 may be implemented using various sensing devices capable of detecting various kinds of sensing targets.

FIG. 3 is a side view illustrating the first boundary surface of the housing.

Referring to FIG. 3, two sensing portions 121 and 122 may be mounted to one boundary surface (e.g., the first boundary surface 101) according to an example embodiment. The sensing portions 121 and 122 may detect the sensing target 220 independently of each other, and may respectively output signals corresponding to the detection result. The sensing portions 121 and 122 may be mounted to an arbitrary position of the first boundary surface 101 according to selection of the designer. For example, as can be seen from FIG. 3, the two sensing portions 120 may be respectively mounted to two positions p1 and p7 of the first boundary surface 101 of the housing 100a. In this case, the two positions p1 and p7 may be respectively adjacent to an upper end 1011 and a lower end 1012 of the first boundary surface 101. In other words, the first sensor 121 may be located adjacent to one end 1011 in an upward direction of the first boundary surface 101, and the second sensor 122 may be located adjacent to the other end 1012 of the first boundary surface 101 arranged to face one end 1011 in the upward direction of the first boundary surface 101. That is, the second sensor 122 may be located adjacent to one end in a downward direction of the first boundary surface 101.

Two sensing portions 123 and 124 may also be mounted to the fourth boundary surface 104 in the same manner as in the first boundary surface 101. The two sensing portions 123 and 124 may be mounted to the fourth boundary surface 104 simultaneously while being located adjacent to one end in the upward direction of the fourth boundary surface 104 and one end in the downward direction of the fourth boundary surface 104.

Although the two sensing portions 121 and 122 and the two sensing portions 123 and 124 are respectively mounted to the first boundary surface 101 and the fourth boundary surface 104 as shown in FIGS. 1 to 3, three or more sensing portions 120 may also be respectively mounted to the first boundary surface 101 and the fourth boundary surface 104 according to an example embodiment. For example, at least one sensor 120 may further be mounted to at least one of the plurality of positions p2 to p6 of the first boundary surface 101 as well as the first and second sensing portions 121 and 122. If three or more sensing portions 120 are mounted, the respective sensing portions 120 may be mounted to the first boundary surface 101 according to a predetermined pattern. For example, the three sensing portions 120 may also be mounted to the first boundary surface 101 at intervals of the same distance. In addition, at least one sensor 120 may be mounted to various positions p1 to p7 capable of being considered by the designer. In addition, according to an example embodiment, only one sensor 120 may also be mounted to each of the first boundary surface 101 and the fourth boundary surface 104.

A sensing target 140 (e.g., sensing target 141(140) may be formed on at least one of the second boundary surface 102 and the third boundary surface 103. In other words, the sensing target 140 may be formed on at least one side surface (e.g. the second boundary surface 102 and/or the third boundary surface 103) located opposing to at least one side surface where the sensor 120 is mounted (e.g. the first boundary surface 101 and/or the fourth boundary surface 104) or a side surface facing).

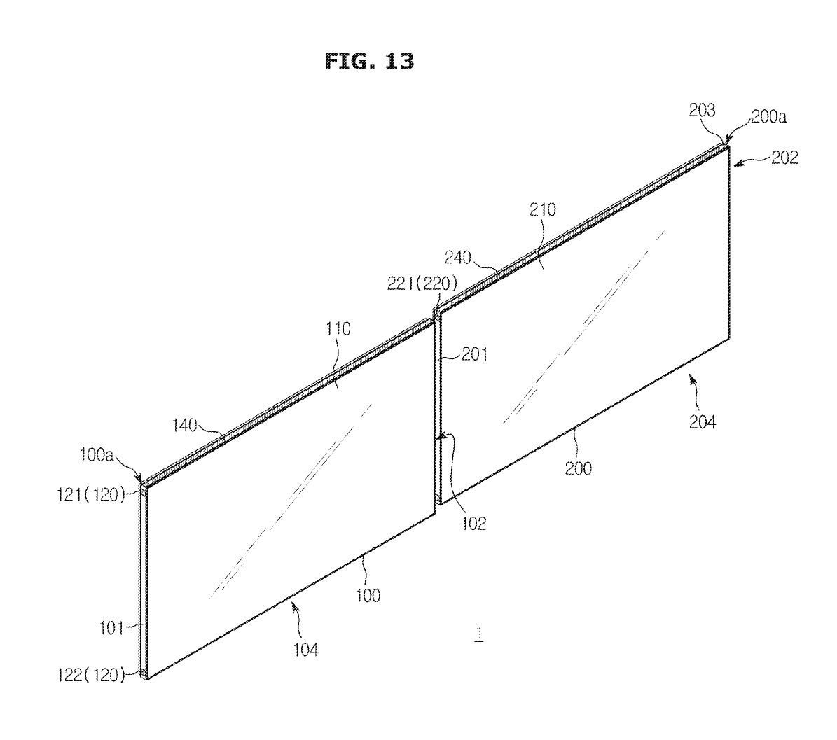

The sensing target 140 may be detected by the sensor 220 (see FIG. 13) of another display apparatus (e.g., the second display apparatus 200 shown in FIG. 13).

In accordance with an example embodiment, the sensing target 140 may be formed to extend from one end of at least one of the second boundary surface 102 and the third boundary surface 103 to the other end of the at least one. The sensing target 140 may be implemented to output different electrical signals according to parts detected by the sensor 220 of the second display apparatus 200. In other words, assuming that the sensing target 140 includes a first part and a second part spaced apart from the first part by a predetermined distance, the sensing result of the first part may be different from the sensing result of the second part. Since the sensor 220 outputs different electrical signals according to respective portions contained in the sensing target 140, it can be determined whether the sensor 220 contacts or approaches portions of the sensing target 140 on the basis of the electrical signal generated from the sensor 220. In addition, relative position(s) of the display apparatus 100 and/or the second display apparatus 200 can also be determined on the basis of the above-mentioned detection result. A detailed description thereof will hereinafter be given.

Example embodiments of the sensing target 140 will hereinafter be described.

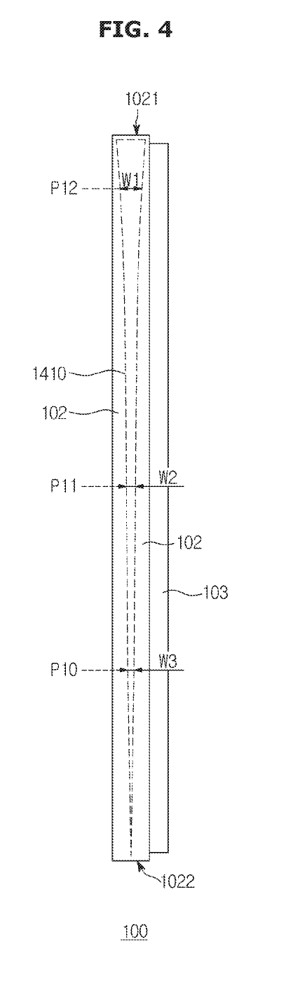

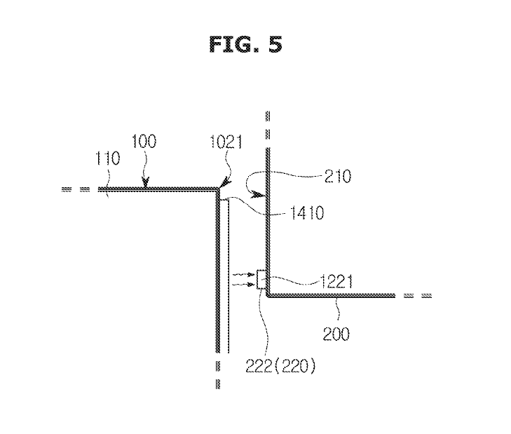

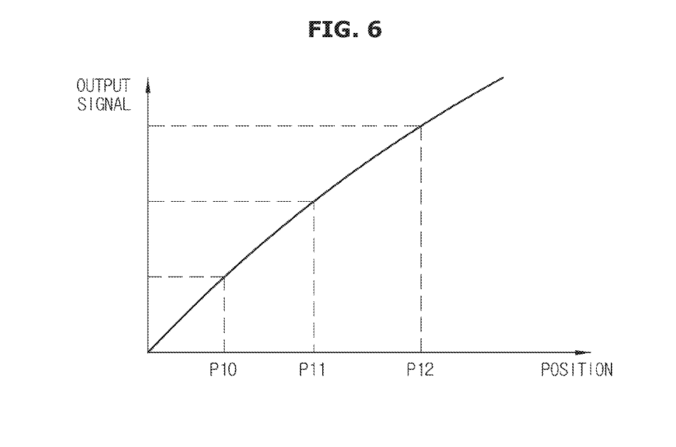

FIG. 4 is a view illustrating the sensing target mounted to the second boundary surface of the housing according to an example embodiment. FIG. 5 is a view illustrating an example embodiment of the sensing target and the sensor of the second display apparatus. FIG. 6 is a graph illustrating the magnitude of an output signal of the sensor of the second display apparatus.

Referring to FIG. 4, the sensing target 140 may extend from one end 1021 of the second boundary surface 102 to the other end 1022, such that the sensing target 140 can be implemented using a conductor 1410 installed to have a predetermined pattern. In this case, one end 1021 may be arranged upward of the display apparatus 100, and the other end 1022 may be arranged downward of the display apparatus 100. The conductor 1410 may be implemented using a metal material. For example, the conductor 1410 may be implemented using various materials capable of inducing inductance, for example, iron (Fe), copper (Cu), aluminum (Al), etc.

The conductor 1410 having a predetermined pattern may be mounted to the second boundary surface 102. The predetermined pattern of the conductor 1410 may be modified in various ways according to selection of the designer.

For example, as shown in FIG. 4, the conductor 1410 may be gradually increased or reduced in width from one end 1021 to the other end 1022. In other words, the width W1 of the conductor 1410 at the first position P12 adjacent to one end 1021 may be relatively larger than the width W2 or W3 of the second position P11 or the third position P10 adjacent to the other end 1022. In addition, the width W3 of the third position P10 adjacent to the other end 1022 may be relatively larger than the width W2 or W3 of the first position P12 or the second position P11 adjacent to the one end 1021. Therefore, the conductor 1410 may have different widths W1 to W3 at the respective positions of the second boundary surface 102, such that different inductances generated from the respective positions may be generated.

The conductor 1410 may have the same reduction rate in width within all regions as necessary. In this case, the conductor 1410 may be implemented as an isosceles triangular shape as shown in FIG. 4, or may be implemented as a right triangular shape as necessary. In addition, the conductor 1410 may be formed in various shapes according to selection of the designer as necessary.

The conductor 1410 may have different width reduction rates at the respective points. For example, the width of the conductor 1410 may be relatively and rapidly reduced in the range from one end 1021 to a certain position, and may be relatively and slowly reduced from the certain position.

Referring to FIG. 5, if the sensor 220 mounted to the first boundary surface 210 of the second display apparatus 200 is an inductance sensor 1221, and if the inductance sensor 1221 approaches one point of the conductor 1410 as the second display apparatus 200 approaches the display apparatus 100, the inductance sensor 1221 may acquire different measurement results according to the width of the approached point, and may output different electrical signals (e.g., electrical signals having different voltages) according to different measurement results. As described above, the conductor 1410 may be formed to have different widths W1 to W3 according to the respective positions P10 to P12, such that the inductance sensor 1221 may output the electrical signals having different voltages V10, V11, and V12 according to the respective positions P10, P11, and P12 as shown in FIG. 6. Therefore, a certain position contacting the inductance sensor 1221 or one position P10, P11 or P12 of the approached conductor 1410 may be determined using the voltage V10, V11 or V12 of the electrical signal. That is, it can be determined whether a portion in contact with or in close proximity to the inductance sensor 1221 is adjacent to one end 1021 or the other end 1022, or whether the portion is located in the vicinity of the center region between the one end 1021 and the other end 1022. As described above, the position of one portion (e.g., a portion in contact with or in close proximity to the inductance sensor 1221 located in the vicinity of one end) of the first boundary surface 210 of the second display apparatus 200 can be determined, such that a relative position between the display apparatus 100 and the second display apparatus 200 can be determined.

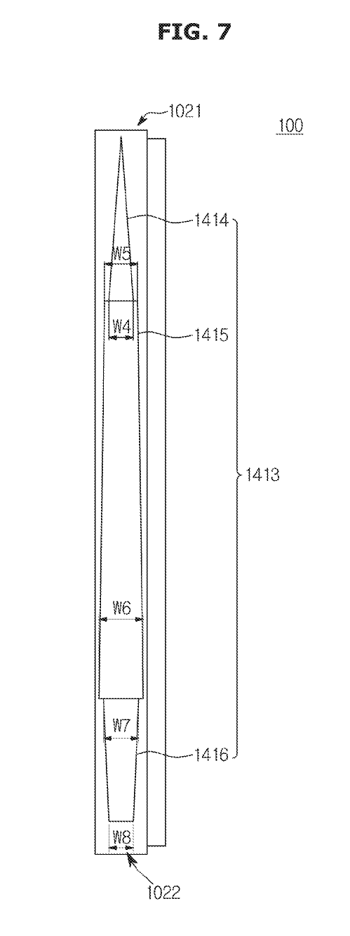

FIG. 7 is a side view illustrating a modification example of the sensing target according to an example embodiment.

Although the conductor 1410 of FIG. 4 extends simultaneously while being gradually reduced in width in the range from one end 1021 to the other end 1022 for convenience of description, the arrangement pattern of the conductor 1410 is not limited thereto.

For example, as shown in FIG. 7, the conductor 1413 according to an example embodiment may include a plurality of portions 1414, 1415 and 1416. The first portion 1414 may be formed to extend from one end 1021 to the first position, the second portion 1415 may be formed to extend from the first position to the second position, and the third portion 1416 may be formed to extend from the second position to the other end 1022. In this case, the widths of the respective parts of the first to third portions 1414 to 1416 may not overlap each other. For example, the first portion 1414 may extend from the width in close proximity to zero “0” to the fourth width W4, the second portion 1415 may extend from the fifth width W5 larger than the fourth width W4 to the sixth width W6, the third portion 1415 may extend simultaneously while being gradually reduced in width in the range from the seventh width W7 (smaller than the sixth width W6 and slightly larger than the fifth width W5) to the eighth width W8 (slightly larger than the fourth width W4). In this case, the conductor 1413 may have different widths at the respective positions, and the second sensor 222 may output different electrical signals at the respective positions. Therefore, a certain position of the conductor 1413 in contact with or in close proximity to the second sensor 222 may be determined in the same manner as described above.

Although the conductors 1410 and 1413 arranged in two or more patterns have been exemplarily disclosed for convenience of description, the scope or spirit of the patterns of the conductors 1410 and 1413 is not limited thereto. The conductors 1410 and 1413 may be formed at the second boundary surface 102 according to at least one pattern configured to allow the sensor 222 to output different electrical signals according to the detection positions.

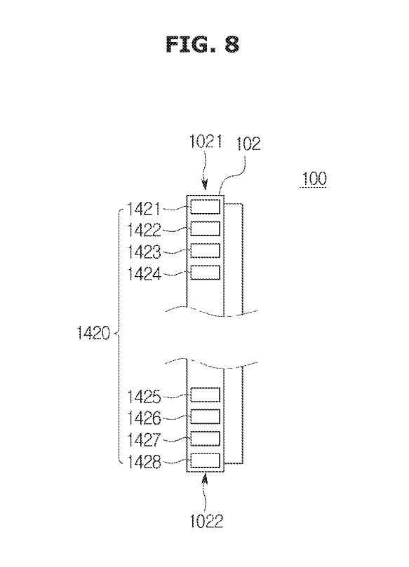

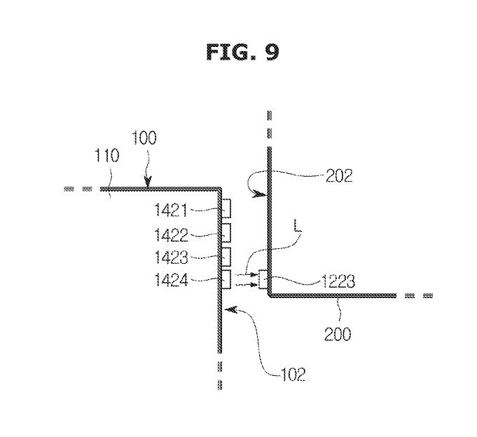

FIG. 8 is a view illustrating the sensing target mounted to the second boundary surface of the housing according to an example embodiment. FIG. 9 is a view illustrating an example embodiment of the sensing target and the sensor of the second display apparatus.

Referring to FIGS. 8 and 9, the sensing target 140 may also be implemented using a light emitting element 1420. For example, the light emitting element 1420 may be implemented using any one of various light emitting devices, for example, an incandescent lamp (light bulb), a halogen lamp, a fluorescent lamp, a sodium lamp, a mercury lamp, a fluorescent mercury lamp, a xenon lamp, an arc light, a neon-tube lamp, an EL lamp, an LED light, or the like. Additionally, various kinds of light emitting devices capable of being considered by the designer may also be used as the light emitting element 1420.

The sensing target 140 may include a plurality of light emitting elements 1421 to 1428 configured to emit different brightness of light. In other words, any one of the plurality of light emitting elements 1421 to 1428 may emit brighter or darker light than the other light emitting element. For example, any one light emitting element (e.g., the first light emitting element 1421) located adjacent to one end 1021 may emit light brighter than the other light emitting element (e.g., the second light emitting element 1422 or the third light emitting element 1423) located adjacent to the other end 1022. Accordingly, different brightness of light may be emitted to the outside at the respective positions of the second boundary surface 102.

In accordance with an example embodiment, the light emitting elements 1421 to 1428 may be sequentially arranged in the rage from one end 1021 to the other end 1022 according to brightness of emission light. In other words, the light emitting element for emitting light having the highest brightness, for example, the first light emitting element 1421, may be arranged in the vicinity of the one end 1021. The light emitting element for emitting light having the second brightness, for example, the second light emitting element 1422, may be arranged adjacent to the other end 1022. The light emitting element for emitting light having the lowest brightness, for example, the eighth light emitting element 1428, may be arranged in the vicinity of the other end 1022.

Of course, the light emitting elements 1421 to 1428 may be sequentially arranged at the second boundary surface 102 in a different way opposite to the above-mentioned description. In addition, the light emitting elements 1421 to 1428 may be arranged at random irrespective of brightness of the emission light.

Although the plurality of light emitting elements 1421 to 1428 can be implemented using the same light emitting device, the light emitting elements 1421 to 1428 are not always implemented using the same light emitting device. Some light emitting elements from among the plurality of light emitting diodes 1421 to 1428 may be implemented using light emitting devices different from some other light emitting elements, or may be implemented using different light emitting devices having different light emitting elements 1421 to 1428.

As shown in FIG. 8, the light emitting elements 1421 to 1428 formed in at least one column may be arranged at the second boundary surface 102 in the range from one end 1021 to the other end 1022. In this case, the light emitting elements 1421 to 1428 may be spaced apart from one another at intervals of the same distance, all or some of the intervals may also be different from each other as necessary.

If the sensor 220 of the second display apparatus 200 is the illumination sensor 1223, the illumination sensor 1223 may contact or approach the second boundary surface 102 as the first boundary surface 201 of the second display apparatus 200 contacts or approaches the second boundary surface 102 of the display apparatus 100.

As can be seen from FIG. 9, the illumination sensor 1223 may detect light (L) emitted from any one (e.g., the fourth light emitting element 1424) of the light emitting elements 1421 to 1424 according to the relative position between the display apparatus 100 and the second display apparatus 200. The illumination sensor 1223 may output the electrical signal corresponding to brightness of the detected light (L). In this case, the plurality of light emitting elements 1421 to 1424 may periodically or successively emit light irrespective of proximity or non-proximity of the illumination sensor 1223, or may be configured to emit light (L) according to proximity of the illumination sensor 1223.

It can be determined whether which one (e.g., the fourth light emitting element 1424) of the light emitting elements 1421 to 1424 has emitted the light (L) detected by the illumination sensor 1223 on the basis of brightness of the detected light (L). The light emitting elements 1421 to 1424 configured to emit different brightnesses of light are arranged at the second boundary surface 102 as described above. If it is determined which one of the light emitting elements 1421 to 1424 has emitted the light (L), the decided light emitting element (e.g., the fourth light emitting element 1424) can be determined, a specific part, which is in contact with or in close proximity to the illumination sensor 1223 arranged in the vicinity of the end of the first boundary surface 202 of the second display apparatus 200, corresponds to a certain part of the second boundary surface 102. Therefore, the relative position between the display apparatus 100 and the second display apparatus 200 can be determined.

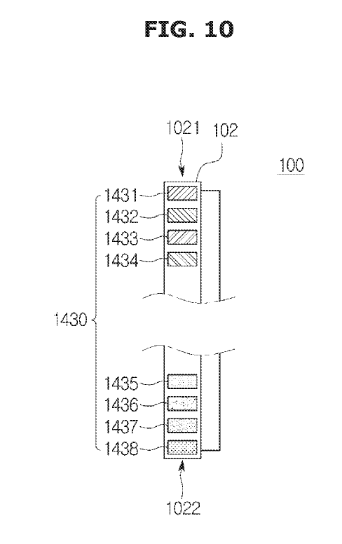

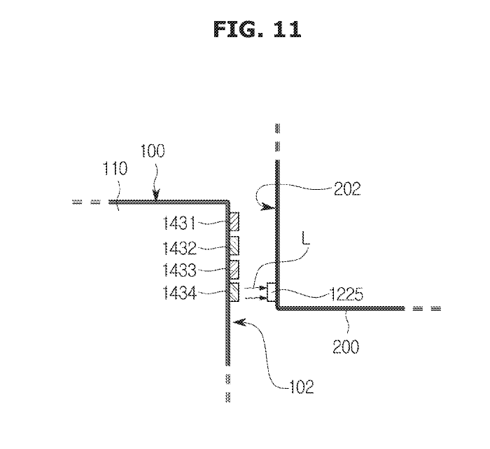

FIG. 10 is a side view illustrating the sensing target mounted to the second boundary surface of the housing according to an example embodiment, and FIG. 11 is a view illustrating an example embodiment of the sensing target and the sensor of the second display apparatus.

Referring to FIGS. 10 and 11, the sensing target 140 may be arranged at the second boundary surface 102, and may be implemented using the light emitting element 1430 configured to emit light having a predetermined wavelength. For example, at least one light emitting element 1430 may be implemented using any one of various light emitting devices, for example, an incandescent lamp (light bulb), a halogen lamp, a fluorescent lamp, a sodium lamp, a mercury lamp, a fluorescent mercury lamp, a xenon lamp, an arc light, a neon-tube lamp, an EL lamp, an LED light, or the like. Additionally, various kinds of light emitting devices capable of being considered by the designer may also be used as the light emitting element 1430. In addition, the light emitting element 1430 may further include a filter or wavelength conversion particle configured to convert a wavelength of light emitted from a light emitting substance such as a filament in such a manner that the light emitting element 1430 can emit light having a predetermined wavelength.

The light emitting elements 1431 to 1438 may be arranged at the second boundary surface 102, and the light emitting elements 1431 to 1438 may emit different wavelengths of light. In accordance with an example embodiment, light emitted from the respective light emitting elements 1431 to 1438 may be visible light. In this case, the respective light emitting elements 1431 to 1438 may emit different colors of light. In accordance with an example embodiment, light emitted from the respective light emitting elements 1431 to 1438 may include not only visible light but also at least one of infrared light and ultraviolet light. Alternatively, light may include only infrared light and/or ultraviolet light.

The light emitting elements 1431 to 1438 may be arranged in at least one column in the range from one end 1021 to the other end 1022 of the second boundary surface 102. In this case, according to an example embodiment, the light emitting elements 1431 to 1438 may be arranged at the second boundary surface 102 in ascending numerical order of wavelengths of light signals emitted from the light emitting elements 1431 to 1438, or may be arranged at the second boundary surface 102 in descending numerical order of wavelengths of light signals emitted from the light emitting elements 1431 to 1438. For example, the light emitting elements 1431 to 1438 may be arranged at the second boundary surface 102 in such a manner that the light emitting element 1431 for emitting red light may be arranged in the vicinity of one end 1021 and the light emitting element 1438 for emitting purple light may be arranged in the vicinity of the other end 1022. Of course, the light emitting elements 1431 to 1438 may also be arranged irrespective of wavelengths of light signals emitted from the plurality of light emitting elements 1431 to 1438 as necessary.

The light emitting elements 1431 to 1438 can be implemented using the same or different light emitting devices in the same manner as in an example embodiment of the sensing target illustrated in FIGS. 8 and 9. The light emitting elements 1431 to 1438 formed in at least one or at least two columns may be arranged at the second boundary surface 102. In this case, the light emitting elements 1431 to 1438 may be spaced apart from one another at intervals of the same distance. However, the respective light emitting elements 1431 to 1438 are not always spaced apart from one another at intervals of the same distance.

Referring to FIG. 11, a color sensor 1225 used as the sensor 220 may be mounted to the second display apparatus 200 so as to detect the light emitting element 1430 configured to emit light having a predetermined wavelength. If the first boundary surface 201 of the second display apparatus 200 contacts or approaches the second boundary surface 102 of the display apparatus 100, the color sensor 1225 can approach any one (i.e., the fourth light emitting element 1434) of the light emitting elements 1431 to 1434 according to the relative position between the display apparatus 100 and the second display apparatus 200, and can detect light (L) emitted from the fourth light emitting element 1434. If light (L) is detected, the color sensor 1225 may output the electrical signal corresponding to a wavelength of the detected light (L).

In the same manner as in an example embodiment of the sensing target, the plurality of light emitting elements 1431 to 1434 may periodically or successively emit light having a predetermined wavelength according to proximity or non-proximity of the color sensor 1225.

As described above, since each of the light emitting elements 1421 to 1424 is configured to emit light having a specific wavelength, it can be recognized whether the color sensor 1225 contacts or approaches positions of the first boundary surface 101 of the display apparatus 100 using the wavelength of the detected light (L), such that the relative position between the display apparatus 100 and the second display apparatus 200 can be recognized.

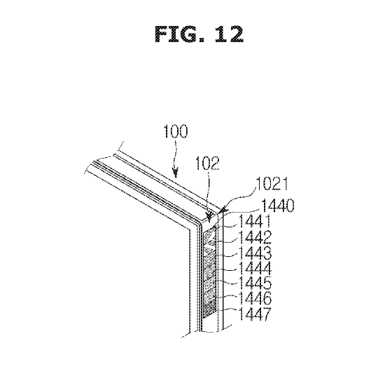

FIG. 12 is a view illustrating the sensing target mounted to the second boundary surface of the housing according to an example embodiment.

Referring to FIG. 12, the sensing target 140 may include a sensing target material 1440 deposited on the external surface of the second boundary surface 102. The sensing target material 1440 may include a plurality of sensing target materials 1441 to 1447 having different colors or different brightnesses. The sensing target material 1140 may include pigments or fluorescent materials, and may further include a flat panel dyed with pigments or including fluorescent materials as necessary.

The plurality of sensing target materials 1441 to 1447 formed in a predetermined pattern may be formed at the external surface of the second boundary surface 102. In this case, assuming that the sensing target materials 1441 to 1447 have different colors, the sensing target materials 1441 to 1447 can also be formed at the second boundary surface 102 according to the order of spectrums of visible light. In addition, assuming that the sensing target materials 1441 to 1447 have different brightnesses, the sensing target materials 1441 to 1447 may be sequentially arranged according to brightness of the sensing target materials 1441 to 1447. In addition, the sensing target materials 1441 to 1447 may be formed at the second boundary surface 102 according to various patterns.

If the sensing target 140 is implemented using the plurality of sensing target materials 1441 to 1447, the sensor 220 of the second display apparatus 200 can be implemented using a light source configured to emit light in the direction of at least one contacted or approached sensing target material 1441, 1442, 1443, 1444, 1445, 1446, or 1447 from among the plurality of sensing target materials 1441 to 1447, and can also be implemented using a light sensor (e.g., a photodiode) configured to detect light reflected from at least one sensing target material 1441, 1442, 1443, 1444, 1445, 1446, or 1447 as well as to emit the electrical signal corresponding to the reflected light. Since the electrical signal generated from the light sensor corresponds to at least one sensing target material 1441, 1442, 1443, 1444, 1445, 1446 or 1447 from which light is reflected, at least one sensing target material 1441, 1442, 1443, 1444, 1445, 1446 or 1447 contacting or approaching the sensor 220 can be determined using the output signal of the sensor 220. Therefore, it can be determined whether the sensor 220 contacts or approaches a certain position of the second boundary surface 102. In addition, the relative position between the display apparatus 100 and the second display apparatus 200 can also be determined on the basis of the above-mentioned decision result.

The display 110 may be configured to display at least one of still images and moving images. The display 110 may be implemented by any one of a Cathode Ray Tube (CRT), a Digital Light Processing (DLP) panel, a Plasma Display Panel (PDP), a Liquid Crystal Display (LCD) panel, an Electro Luminescence (EL) panel, an Electrophoretic Display (EPD) panel, an Electrochromic Display (ECD) panel, a Light Emitting Diode (LED) panel, and an Organic Light Emitting Diode (OLED) panel, without being limited thereto. The display 110 may be implemented using a curved display or a bendable display. In addition, the display 110 may be implemented using various devices capable of being considered by the designer.

The display 110 may display an image corresponding to the position of the display apparatus 100, and the position of the display apparatus 100 may be determined on the basis of the electrical signal generated from the sensor 120 according to the detection result of the sensor 120. In this case, the position of the display apparatus 100 may include a relative position regarding the other display apparatus (e.g., the second display apparatus 200) contacting or approaching the display apparatus 100. In addition, the image corresponding to the position of the display apparatus 100 may be the entire image or some parts of the entire image.

A multi-display system including two display apparatuses will hereinafter be described in detail.

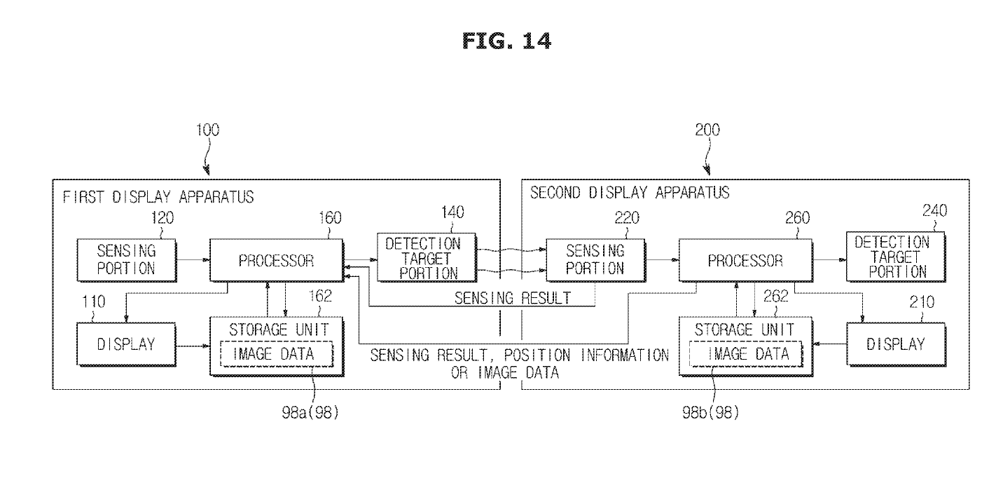

FIG. 13 is a perspective view illustrating the multi-display system including two display apparatuses according to an example embodiment, and FIG. 14 is a block diagram illustrating the multi-display system including two display apparatuses according to an example embodiment.

Referring to FIGS. 13 and 14, the multi-display system 1 may include at least two display apparatuses, i.e., a first display apparatus 100 and a second display apparatus 200.

In accordance with an example embodiment, the first display apparatus 100 may include a housing 100a including a plurality of boundary surfaces 101 to 104, at least one sensor 120 mounted to at least one (e.g., the first boundary surface 101 and the fourth boundary surface 104) of the plurality of boundary surfaces 101 to 104, at least one sensor 140 mounted to at least one (e.g., the second boundary surface 102 and the third boundary surface 103) of the plurality of boundary surfaces 101 to 104, and a display 110 capable of displaying images corresponding to the relative position of the first display apparatus 100.

In accordance with an example embodiment, the second display apparatus 200 may include a housing 2001 including a plurality of boundary surfaces 201 to 204, at least one sensor 220 mounted to at least one boundary surface of the plurality of boundary surfaces 201 to 204, at least one sensing target 240 mounted to at least one boundary surface from among the plurality of boundary surfaces 101 to 104, and a display 210 capable of displaying images corresponding to the relative position of the second display apparatus 200. The housing 200a, the sensor 220, the sensing target 240, and the display 210 of the second display apparatus 200 may be identical to the housing 100a, the sensor 120, the sensing target 140, and the display 110 of the first display apparatus 100. Of course, according to example embodiments, the housing 200a, the sensor 220, the sensing target 240, and the display 210 of the second display apparatus 200 may be achieved by partially modifying the housing 100a, the sensor 120, the sensing target 140, and the display 110 of the first display apparatus 100.

The housings 100a and 200a, the sensing portions 120 and 220, the sensing targets 140 and 240, and the displays 110 and 210 have already been disclosed with reference to FIGS. 1 to 12, and as such a detailed description thereof will herein be omitted for convenience of description.

The first display apparatus 100 may further include a processor 160 for controlling overall operation of the display apparatus 100, and a storage 162 for temporarily or non-temporarily storing various programs or images related to the operation of the display apparatus 100. Similarly, the second display apparatus 200 may include a processor 260 and a storage 262. The processors 160 and 260 and the storages 162 and 262 may be embedded in the housings 100a and 200a. In accordance with an example embodiment, at least one of the processor 160 of the first display apparatus 100 and the processor 260 of the second display apparatus 200, or at least one of the storage 162 of the first display apparatus 100 and the storage 262 of the second display apparatus 200 will herein be omitted as necessary.

In accordance with an example embodiment, the processors 160 and 260 may receive the detection results of the sensing portions 120 and 220 from the sensing portions 120 and 220 such that the electrical signals indicating the detection results of the sensing portions 120 and 220 can be transferred to the processors 160 and 260. The processors 160 and 260 may determine images to be displayed on the displays 110 and 210 on the basis of the received detection results, and may control the displays 110 and 210 to display the determined images.

The processors 160 and 260 may control operations of the detection target portions 140 and 240. For example, assuming that the detection target portions 140 and 240 are respectively implemented as the light emitting elements 1420 and 1430, the light emitting elements 1420 and 1430 may emit light having at least one brightness or light having at least one wavelength. In this case, the processors 160 and 260 may control the light emitting elements 1420 and 1430 to periodically emit light, or may control the light emitting elements 1420 and 1430 to successively emit light. In addition, the processors 160 and 260 may determine the presence or absence of contact or proximity of the first display apparatus 100 and the second display apparatus 200 using a proximity sensor. If the first display apparatus 100 and the second display apparatus 200 are in contact with each other or in close proximity to each other, the processors 160 and 260 may control the light emitting elements 1420 and 1430 to emit light.

In addition, the processors 160 and 260 may control operations of the sensing portions 120 and 220. For example, assuming that each of the sensing portions 120 and 220 is an inductance sensor 1221 or assuming that the sensing portions 120 and 220 include a light source and a light sensor, the processors 160 and 260 may transmit a control signal to the inductance sensor 1221 or the light source, such that the inductance sensor 1221 may detect the width of a specific point of each of the sensing targets 140 and 240 or the light sensor may detect light reflected from the sensing targets 140 and 240.

Constituent elements of the processors 160 and 260 and other display apparatuses 100 and 200 can be controlled using a control signal. Here, the control signal may be transmitted to the respective constituent elements and/or other display apparatuses 100 and 200 using a circuit, a conductive wire, and/or a wireless communication module, etc.

The processors 160 and 260 may be implemented using at least one semiconductor chip and associated constituent elements. The processors 160 and 260 may include, for example, a micro controller unit (MCU), a micro processor unit (MPU), etc.

The storages 162 and 262 (e.g., memory) may store image data 98 as shown in FIG. 14. In this case, any one of the storage 162 of the first display apparatus 100 and the storage 262 of the second display apparatus 200 may store image data 98. The storage 162 of the first display apparatus 100 and the storage 262 of the second display apparatus 200 may respectively store image data 98a and 98b independently of each other. In this case, the image data 98a and 98b respectively stored in the storage 162 of the first display apparatus 100 and the storage 262 of the second display apparatus 200 may be identical to each other or different from each other. The image data 98 may be reproduced in the form of still images or moving images by operations of the processors 160 and 260 and the displays 110 and 210, and then displayed for user recognition.

The storages 162 and 262 may be implemented using a magnetic drum storage, a magnetic disc storage, and/or a semiconductor storage. The semiconductor storage may be implemented using one or more volatile memory devices such as a Random Access Memory (RAM), or may be implemented using at least one of non-volatile memory devices, for example, a Read Only Memory (ROM), a Programmable ROM (PROM), an Erasable Programmable ROM (EPROM), an Electrically Erasable Programmable Read-Only Memory (EEPROM), a NAND flash memory, etc.

The first display apparatus 100 and the second display apparatus 200 may be interconnected to communicate with each other. For example, the first display apparatus 100 may transmit and receive predetermined data or information to and from the second display apparatus 200 through a wired communication network and/or a wireless communication network.

To this end, the first display apparatus 100 and the second display apparatus 200 may respectively include a communicator for connecting to a wired communication network and/or a communicator for connecting to a wireless communication network. Here, the wired communication network may be implemented using various cables, for example, a pair cable, a coaxial cable, an optical fiber cable, or an Ethernet cable. The wireless communication network may be implemented using at least one of short-range communication technology and long-range communication technology. The short-range communication technology may be implemented using at least one of a Wireless LAN, Wi-Fi, Bluetooth, ZigBee, CAN communication, Wi-Fi Direct (WFD), ultra-wideband communication, infrared Data Association (IrDA), Bluetooth Low Energy (BLE), and Near Field Communication (NFC). The long-range communication technology may be implemented using any of various communication technologies based on various mobile communication protocols, for example, 3GPP, 3GPP2, World Interoperability for Microwave Access (WiMAX), etc.

A process for displaying images on the displays 110 and 210 according to control signals of the processors 160 and 260 will hereinafter be described in detail.

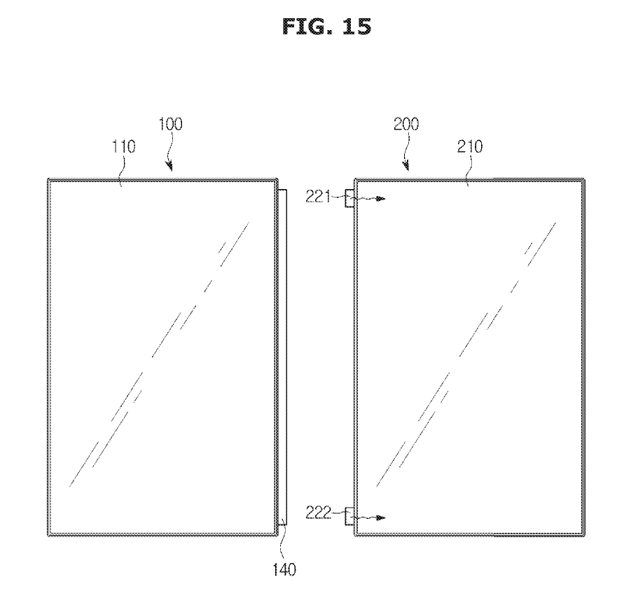

FIG. 15 is a view illustrating an example in which the sensor of the second display apparatus outputs a signal based on the sensing result of the sensing target of the first display apparatus.

Referring to FIGS. 13 and 15, the second display apparatus 200 may contact or approach the first display apparatus 100. In this case, the first boundary surface 201 of the second display apparatus 200 may contact or approach the second boundary surface 102 of the first display apparatus 100. At least one of the plurality of sensing portions 221 and 222 mounted to the first boundary surface 201 of the second display apparatus 200 may approach or contact the sensing target 140 formed at the second boundary surface 102 of the first display apparatus 100, such that the sensor 220 of the second display apparatus 200 may output an electrical signal based on the sensing result.

In accordance with an example embodiment, the electrical signal may be transferred to the processor 260 of the second display apparatus 200. The processor 260 may determine whether the sensor (i.e., at least one of the sensing portions 221 and 222) having outputted the electrical signal is any one (i.e., at least one of the sensing portions 221 and 222) of the sensing portions 221 and 222, may analyze the electrical signal generated from the sensor (i.e., at least one of the sensing portions 221 and 222) having outputted the electrical signal, and may determine whether the sensor (i.e., at least one of the sensing portions 221 and 222) having outputted the electrical signal contacts or approaches a certain position of the second boundary surface 102 of the first display apparatus 100. In this case, the processor 260 may compare data stored in the storage 262 with the electrical signal generated from the sensor (i.e., at least one of the sensing portions 221 and 222) having outputted the electrical signal, and may determine whether the sensor (i.e., at least one of the sensing portions 221 and 222) having outputted the electrical signal contacts or approaches a certain position of the second boundary surface 102 of the first display apparatus 100.

For example, assuming that the sensing target 140 is composed of conductors 1410 and 1413 and the sensor 220 is an inductance sensor 1221, the storage 262 may store not only the inductance sensor 1221's output value classified into a plurality of levels (e.g., first to tenth levels), but also information regarding different positions corresponding to the first to tenth levels. In more detail, for example, the first level stored in the storage 262 may correspond to a peripheral portion of one end 1021 of the second boundary surface 102, the second level stored in the storage 262 may correspond to a predetermined region formed when one end 1021 of the second boundary surface 102 is spaced apart from the other end 1022 by a predetermined distance, and the tenth level stored in the storage 262 may store information regarding a peripheral portion of the other end 1022 of the second boundary surface 102.

If the inductance sensor 1221 outputs the electrical signal, the processor 160 may compare the electrical signal generated from the inductance sensor 1221 with the output value stored in the storage 262, may determine the level of the electrical signal generated from the inductance sensor 1221, and may determine one position of the second boundary surface corresponding to the decided level on the basis of information indicating the position corresponding to each level.

Assuming that the detection sensor 140 is a light emitting element 1420 emitting different brightnesses of light and the sensor 220 is an illumination sensor 1223, the storage 262 may store not only brightness values classified into the plurality of levels (i.e., the first to tenth levels), but also information regarding different positions corresponding to the first to tenth levels. The processor 260 may determine the level of the electrical signal generated from the illumination sensor 1223 using the stored information, and may determine one position of the second boundary surface 102 corresponding to the decided level on the basis of position information corresponding to each level.

In addition, assuming that the sensing target 140 is composed of a light emitting element 1430 emitting different colors of light and the color sensor 1225, the storage 262 may store information regarding different positions correspond to different colors, and the processor 260 may determine not only the sensing result regarding the color generated from the color sensor 1225, but also one position of the second boundary surface 102 corresponding to the sensed color using position information corresponding to each color.

The processor 260 may collectively determine not only one position of the second boundary surface 102 that contacts or approaches the sensor (i.e., at least one of the sensing portions 221 and 222) having outputted the electrical signal based on the analysis result of the electrical signal generated from the sensor (i.e., at least one of the sensing portions 221 and 222), but also the position of the sensor (i.e., at least one of the sensing portions 221 and 222) having outputted the electrical signal, and may thus determine the relative position between the first display apparatus 100 and the second display apparatus 200. In other words, assuming that one position of the second boundary surface 102 that contacts or approaches the sensor (i.e., at least one of the sensing portions 221 and 222) having outputted the electrical signal is given, the processor 260 may recognize the relative position of the first display apparatus 100 on the basis of the sensor (i.e., at least one of the sensing portions 221 and 222) having outputted the electrical signal. The position of the second display apparatus 200 of the sensor (i.e., at least one of the sensing portions 221 and 222) having outputted the electrical signal is a given value, such that the processor 260 may acquire not only a relative position of the first display apparatus 100 on the basis of the second display apparatus 200, but also a relative position of the second display apparatus 200 on the basis of the first display apparatus 100.

For example, as shown in FIG. 15, assuming that the first display apparatus 100 and the second display apparatus 200 are arranged in parallel, each of the first sensor 221 and the second sensor 222 outputs the electrical signal, the first sensor 221 may output a signal corresponding to the resultant signal obtained when a peripheral portion of one end 1021 of an upward direction of the second boundary surface 102 is detected, and the second sensor 222 may output a signal corresponding to the resultant signal obtained when a peripheral portion of one end 1022 of a downward direction of the second boundary surface 102 is detected. Therefore, the processor 260 may determine that the first sensor 221 is located in the vicinity of one end 1021 of the upward direction of the second boundary surface 102, and may determine that the second sensor 222 is located in the vicinity of one end 1022 of the downward direction of the second boundary surface 102. As a result, the first display apparatus 100 and the second display apparatus 200 are arranged in parallel, and the second display apparatus 200 may be arranged in a manner that the first boundary surface 202 faces the second boundary surface 102 of the first display apparatus 100. Therefore, the processor 260 may determine the relative position between the first display apparatus 100 and the second display apparatus 200.

If the relative position between the two display apparatuses 100 and 200 is determined as described above, the processor 260 of the second display apparatus 200 may determine which image will be displayed on the display 210 of the second display apparatus 200.

In accordance with an example embodiment, the processor 260 may control the display 110 of the first display apparatus 100 to display images related to images to be displayed on the display 110 of the first display apparatus 100 according to a predetermined condition. For example, the processor 260 may control the display 210 of the second display apparatus 200 to display the same image as the display 110 of the first display apparatus 100. Alternatively, if the order of plural images is defined, the display 210 of the second display apparatus 200 may display images defined to precede or lag images to be displayed on the display 110 of the first display apparatus 100.

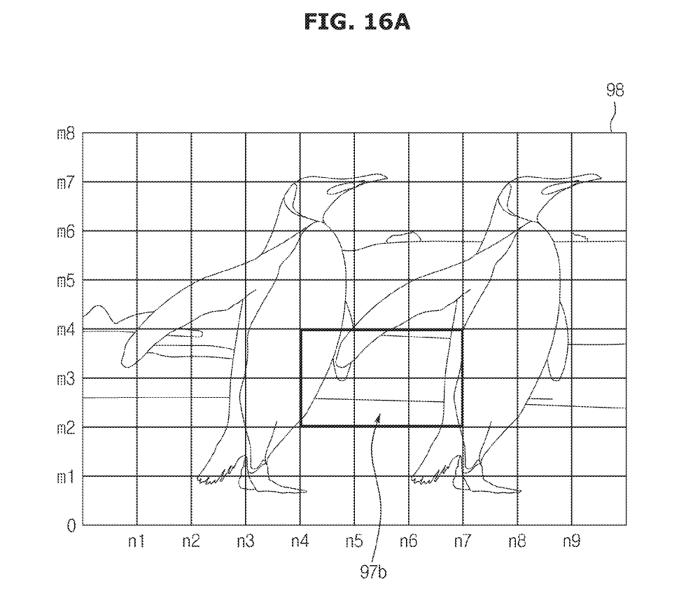

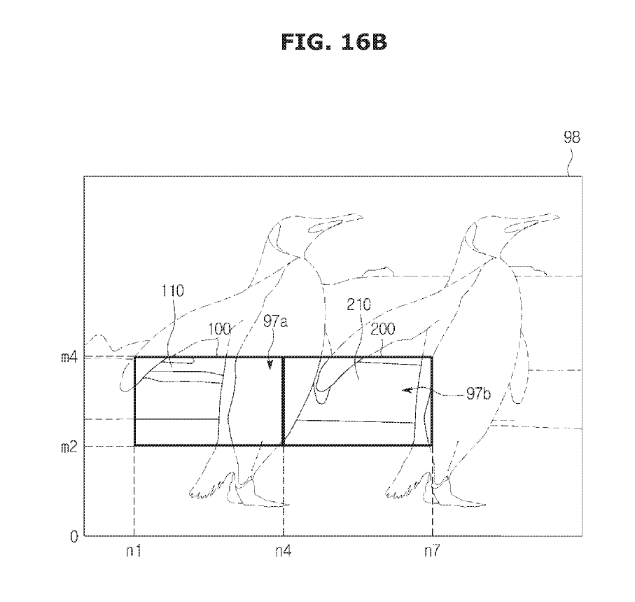

FIG. 16A is a view illustrating an example of images according to an example embodiment. FIG. 16B is a view illustrating an example in which each display apparatus of the multi-display system displays images.

Referring to FIGS. 16A and 16B, the processor 260 may control the display 210 of the second display apparatus 200 to display some parts 97b of one image 98. The processor 260 may determine some parts 97b of the images 98 to be displayed on the display 210 in various ways. In addition, the processor 260 may also determine the size or resolution of some parts 97b of the images 98 to be displayed on the display 210 in various ways.

For example, the processor 260 may determine some parts 97b to be displayed from among the images 98 according to the relative position of the second display apparatus 200. In more detail, the processor 260 may determine coordinates (e.g., first coordinates (n4, m4), second coordinates (n7, m4), third coordinates (n7, m2), and fourth coordinates (n4, m2)) of some parts 97b to be displayed on the display 210 within the images 98 according to the relative position of the second display apparatus 200 and the size of some parts 97b of the images 98 to be displayed. Subsequently, the processor 260 may extract the inside images 97b of the first coordinates (n4, m4), the second coordinates (n7, m4), the third coordinates (n7, m2), and the fourth coordinates (n4, m2), may transmit image data regarding the extracted images 97b to the display 210, and may control the display 210 to display some parts 97b of the images 98. In this case, the processor 260 may temporarily or non-temporarily store the extracted images 97b as necessary, and may transmit the image data to the display 210.

In accordance with an example embodiment, the processor 260 may determine the relative position of the images 98 corresponding to the relative position of the second display apparatus 200 on the basis of a predetermined reference position according to a predefined condition, and may also extract coordinates of some parts 97b to be displayed on the display 210 on the basis of the relative position of the decided images 98. In this case, the predetermined reference position may be one edge (e.g., zero point (0, 0)) of the images 98, or may be an arbitrary position of the images 98.

According to the above-mentioned method, the display 210 may display images corresponding to the relative position of the second display apparatus 200, or may display some parts of the images.

Meanwhile, the first display apparatus 100 may receive various kinds of information from the second display apparatus 200 in which the sensor 220 having detected the sensing target 140 of the first display apparatus 100 is mounted, and may determine images 97a to be displayed on the display 110 of the first display apparatus 100 on the basis of the various kinds of information.

The images 97a to be displayed on the display 110 of the first display apparatus 100 may be identical to or different from the images 97b to be displayed on the display 210 of the second display apparatus 200. The images 97a to be displayed on the display 110 of the first display apparatus 100 and the images 97b to be displayed on the display 210 of the second display apparatus 200 may be some parts of the same image. In this case, the images 97a to be displayed on the display 110 of the first display apparatus 100 may partially overlap the images 97b to be displayed on the display 210 of the second display apparatus 200 as necessary.

In accordance with an example embodiment, the electrical signal generated from the sensor 220 of the second display apparatus 200 may be directly transferred to a communicator of the second display apparatus 200 or may be transferred to the communicator through the processor 260, and may be transferred to the first display apparatus 100 through a wired communication network and/or a wireless communication network. Upon receiving the electrical signal from the sensor 220, the processor 160 of the first display apparatus 100 may determine the images 97a to be displayed on the display 110 of the first display apparatus 100 either using the same method as in the processor 260 of the second display apparatus 100 or using a modified method partially different from that of the processor 260 of the second display apparatus 100.

In accordance with an example embodiment, the processor 260 may acquire the relative position of the second display apparatus 200, may determine the relative position of the first display apparatus 100 on the basis of the relative position of the second display apparatus 200, and may transmit the determined relative position of the first display apparatus 100 to the first display apparatus 100. Upon receiving the relative position of the first display apparatus 100, the processor 160 of the first display apparatus 100 may determine the images 97a to be displayed on the display 110 of the first display apparatus 100 either using the same method as described above or using a partially modified method.

In accordance with an example embodiment, the processor 260 may acquire the relative position of the second display apparatus 200, and may transmit information regarding the relative position of the second display apparatus 200 to the first display apparatus 100 at the same time that the images 97b to be displayed are decided or at a different time from the time at which the images 97b to be displayed are decided. The processor 160 of the first display apparatus 100 may acquire the relative position of the first display apparatus 100 using the relative position of the second display apparatus 200, and may determine the images 97a to be displayed on the display 110 of the first display apparatus 100 on the basis of the relative position of the first display apparatus 100 either using the same method as described above or using a partially modified method.

In accordance with an example embodiment, the processor 260 may determine the images 97b to be displayed on the display 210 of the second display apparatus 200, and may transmit the images 97b to be displayed on the display 210 to the first display apparatus 100. In this case, the relative positions of the first display apparatus 100 and the second display apparatus 200 may also be simultaneously transmitted to the first display apparatus 100. The processor 160 of the first display apparatus 100 may determine the images 97b to be displayed on the display 110 of the first display apparatus 100 using the images 97b to be displayed on the display 210 of the second display apparatus 200. In this case, if the images 97b to be displayed on the display 210 of the second display apparatus 200 are some parts of a certain image 98, the processor 160 may determine some parts of the image 98 to be displayed on the display 110 of the first display apparatus 100 in consideration of the relative positions of the first display apparatus 100 and the second display apparatus 200, and may thus determine the images 97a to be displayed on the display 110 of the first display apparatus 100.

In accordance with an example embodiment, the processor 260 of the second display apparatus 200 may determine not only the image 97b to be displayed on the display 210 of the second display apparatus 200, but also the image 97a to be displayed on the display 110 of the first display apparatus 100 at the same time or at different times. In addition, the processor 260 of the second display apparatus 200 may transmit the image 97a to be displayed on the display 110 of the first display apparatus 100 to the first display apparatus 100. In this case, the processor 260 of the second display apparatus 200 may determine the images 97a to be displayed on the display 110 of the first display apparatus 100 in consideration of the relative positions of the first display apparatus 100 and the second display apparatus 200. The processor 160 of the first display apparatus 100 may control the display 110 to display the images 97a based on the determined result of the second display apparatus 200.

Images to be displayed on the display 110 of the first display apparatus 100 may be determined using at least one of the above-mentioned methods, such that the first display apparatus 100 and the second display apparatus 200 may display proper images 97a and 97b corresponding to the relative positions of the respective apparatuses 100 and 200.

Although the above-mentioned description has exemplarily disclosed that the processor 260 of the second display apparatus 200 determines the relative positions of the first display apparatus 100 and the second display apparatus 200 and a method for determining the images 97b to be displayed on the display 210 of the second display apparatus 200 on the basis of signals detected by the sensor 220, it should be noted that the processor 160 of the first display apparatus 100 can determine the images 97b to be displayed on the display 210 of the second display apparatus 200.

For example, the result detected by the sensor 220 of the second display apparatus 200 may first be transferred to the processor 160 of the first display apparatus 100 instead of the processor 260 of the second display apparatus 200. The processor 160 of the first display apparatus 100 may determine not only the relative positions of the first display apparatus 100 and the second display apparatus 200, but also the images 97a to be displayed on the display 110 of the first display apparatus 100, using the result detected by the sensor 220 of the second display apparatus 200. In this case, the processor 160 of the first display apparatus 100 may transmit the relative positions of the first display apparatus 100 and the second display apparatus 200 and/or information regarding the images 97a to be displayed on the display 110 of the first display apparatus 100 to the second display apparatus 200. In addition, the processor 160 may further determine the images 97b to be displayed on the display 210 of the second display apparatus 200, and may then transmit information regarding the decided images 97b to the second display apparatus 200.

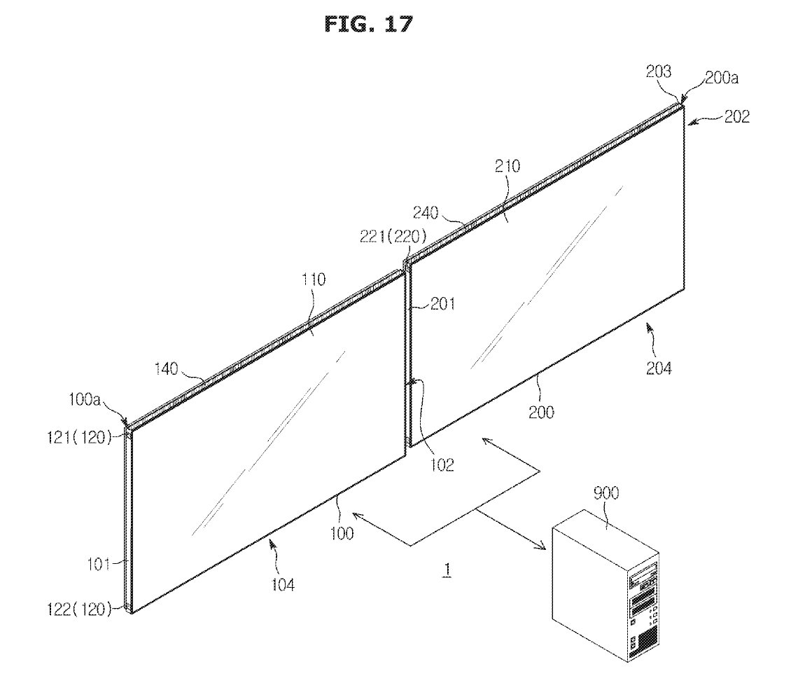

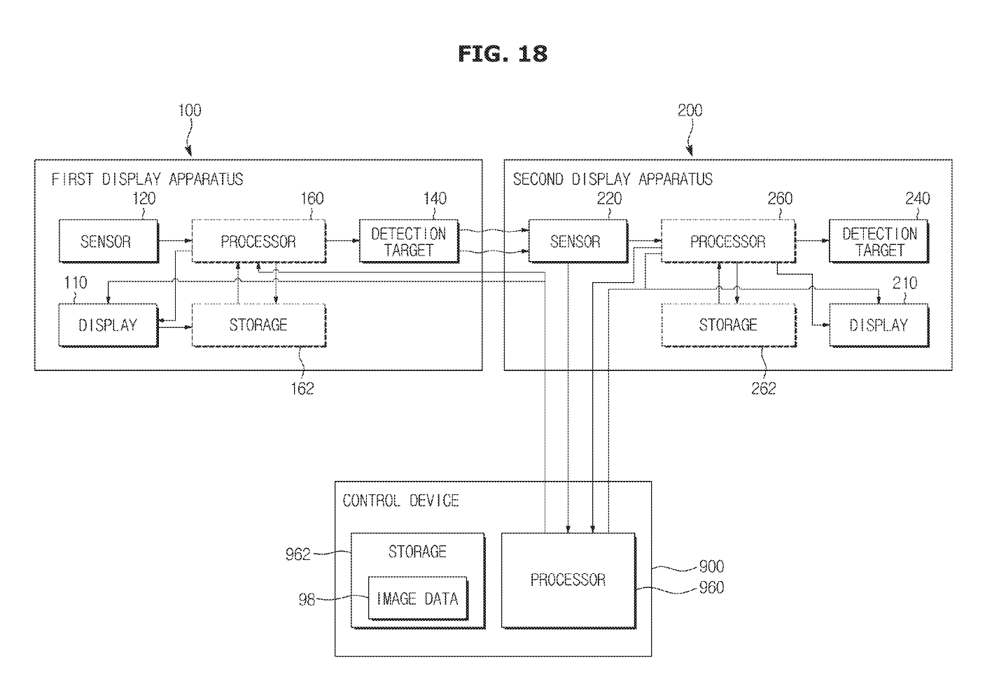

FIG. 17 is a perspective view illustrating a multi-display system including two display apparatuses according to an example embodiment. FIG. 18 is a block diagram illustrating a multi-display system including two display apparatuses according to an example embodiment.

Referring to FIGS. 17 and 18, the multi-display system 2 may include at least two display apparatuses, i.e., the first display apparatus 100 and the second display apparatus 200, and may further include a control device 900 arranged independently from the first display apparatus 100 and the second display apparatus 200.

In accordance with an example embodiment, the first display apparatus 100 and the second display apparatus 200 may respectively include the housings 100a and 200a, one or two sensing portions 120 and 220, one or more sensing targets 140 and 240, and the displays 110 and 210. The housings 100a and 200a, the sensing portions 120 and 220, the sensing targets 140 and 240, and the displays 110 and 210 of the first display apparatus 100 and the second display apparatus 200 are similar to above, and thus, a detailed description thereof will herein be omitted for convenience of description.

The control device 900 may communicate with two or more display apparatuses 100 and 200 through a wired communication network and/or a wireless communication network. In this case, the control device 900 may independently communicate with each of the two display apparatuses 100 and 200, or may communicate with the other display apparatus (e.g., the second display apparatus 200) through any one (e.g., the first display apparatus 100) of the at least two display apparatuses 100 and 200.

For example, the control device 900 may be implemented using a computing device (e.g., a desktop computer, laptop, smartphone, tablet PC, and/or a server computer, etc.) capable of controlling at least two display apparatuses 100 and 200. The control device 900 may be independently manufactured to control at least two display apparatuses 100 and 200.

In accordance with an example embodiment, the control device 900 may include a processor 960 and a storage 962 capable of storing image data 98 as shown in FIG. 18. The processor 960 of the control device 900 may be implemented using at least one semiconductor chip and associated components in the same manner as in the processor 160 of the first display apparatus 100 and the processor 260 of the second display apparatus 200. In addition, the storage 962 of the control device may be implemented using a magnetic drum storage, a magnetic disc storage, and/or a semiconductor storage in the same manner as in the storages 162 and 262 of the first display apparatus 100 and the second display apparatus 200.

The processor 960 of the control device 900 may be configured to perform the operations of the processors 160 and 260 of the first display apparatus 100 and the second display apparatus 200.

In accordance with an example embodiment, the processor 960 of the control device 900 may be configured to perform all or some of one or more operations of the processor 160 of the first display apparatus 100 and the processor 260 of the second display apparatus 200.

For example, the processor 960 of the control device 900 may receive the sensing result of the sensor 220 of the second display apparatus 200, may determine the relative positions of the first display apparatus 100 and the second display apparatus 200 on the basis of the received sensing result, and may determine the images 97a and 97b to be respectively displayed on the displays 110 and 210 of the first display apparatus 100 and the second display apparatus 200 on the basis of the relative positions of the first display apparatus 100 and the second display apparatus 200. In accordance with an example embodiment, the processor 960 of the control device 900 may determine the relative positions of the first display apparatus 100 and the second display apparatus 200, and may transmit the determined relative position to the processor 160 of the first display apparatus 100 and the processor 260 of the second display apparatus 200. In this case, the images 97a and 97b to be respectively displayed on the displays 110 and 210 may be determined not only by the processor 160 of the first display apparatus 100 but also by the processor 260 of the second display apparatus 200.

Assuming that the processor 960 of the control device 900 determines not only the relative positions of the first display apparatus 100 and the second display apparatus 200 but also the images to be displayed on the displays 110 and 210, the processor 160 of the first display apparatus 100 and the processor 260 of the second display apparatus 200 will herein be omitted as necessary. In addition, the storages 162 and 262 of the first display apparatus 100 and the second display apparatus 200 will herein be omitted as necessary.

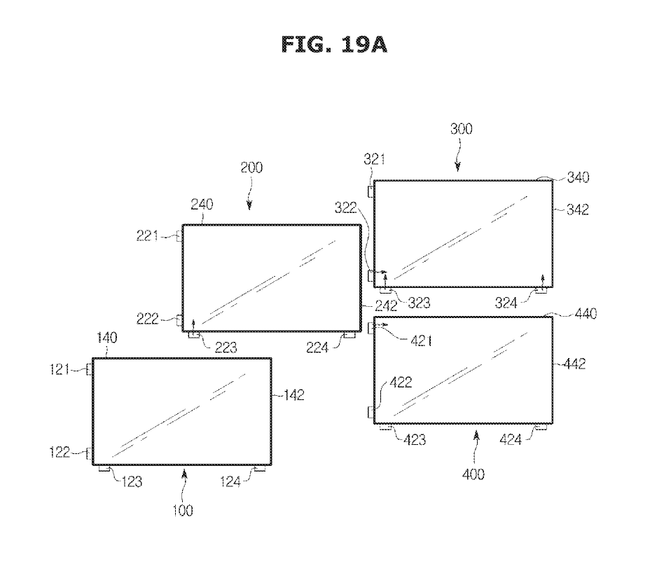

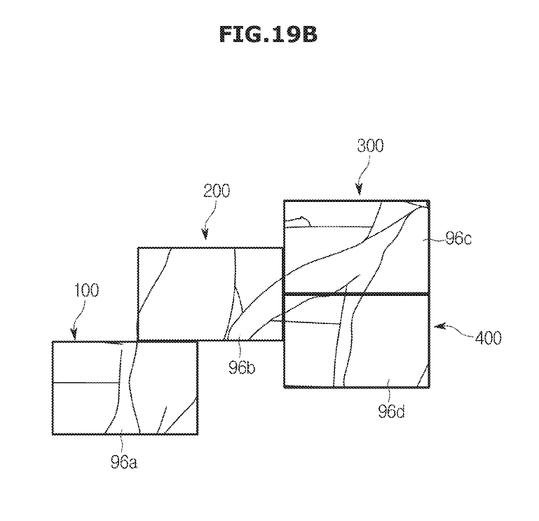

FIG. 19A is a first view illustrating an example embodiment of the multi-display system including a plurality of display apparatuses, and FIG. 19B is a second view illustrating an example embodiment of the multi-display system including a plurality of display apparatuses.

Referring to FIGS. 19A and 19B, the multi-display system 3 may include three or more display apparatuses, for example, the first display apparatus 100, the second display apparatus 200, the third display apparatus 300, and the fourth display apparatus 400.

Referring to FIGS. 19A and 19B, the first to fourth display apparatuses 100 to 400 may include the displays (110, 210, 310, 410), at least one sensor (121, 122, 221, 222, 321, 322, 421, 422), and at least one sensing target (140, 240, 340, 440, 142, 242, 342, 442). The displays (110, 210, 310, 410), the housings (100a, 200a, 300a, 400a), at least one sensor (120, 220, 320, 420), and at least one sensing target (140, 240, 340, 440) of the display apparatuses 100 to 400 have already been described as described above, as such a detailed description thereof will herein be omitted for convenience of description.

The first to fourth display apparatuses 100 to 400 may be typically arranged, or may be atypically arranged as shown in FIGS. 19A and 19B.

In this case, according to typical arrangement of the first to fourth display apparatuses 100 to 400, an upper boundary surface and a lower boundary surface of a certain display apparatus are arranged in a line at an upper boundary surface and a lower boundary surface of the other display apparatus arranged at a left side or a right side, and a left boundary surface and a right boundary surface of a certain display apparatus are arranged in a line at a left boundary surface and a right boundary surface of the other display apparatus located at an upper or lower side. If the first to fourth display apparatuses 100 to 400 are arranged as described above, the display apparatuses may be arranged in at least one column in parallel to each other, or may be symmetrically arranged. The combination shape of the plural display apparatuses may be identical or similar to the shape of one display apparatus. For example, the combination shape of the plural display apparatuses may be formed in a square shape or in other similar shapes. Such typical arrangement may further include a shape formed when at least one display apparatus or at least two display apparatuses are omitted from the above-mentioned arrangement.

Atypical arrangement may denote that the display apparatuses are not typically arranged. For example, as shown in FIGS. 19A and 19B, a lower boundary surface of any one display apparatus (e.g., the third display apparatus 300) and a lower boundary surface of the other display apparatus (e.g., the second display apparatus 200) are not arranged in a line. In addition, such atypical arrangement may further include an exemplary case in which some of the display apparatuses are typically arranged and some other of the display apparatuses are atypically arranged.

If the display apparatuses 100 to 400 are atypically arranged as shown in FIG. 19A, any one (e.g., the third sensor 223) of the sensing portions 221 to 224 of the second display apparatus 200 may detect the sensing target 140 of the first display apparatus 100 and output an electrical signal. In the same manner as described above, the second display apparatus 200 may display the image 96b corresponding to the position of the second display apparatus 200, and the first display apparatus 100 may also display the image 96a corresponding to the position of the first display apparatus 100.

Similarly, at least one of the sensing portions 321 to 324 of the third display apparatus 300 may detect the sensing targets 240 and 440 of the other display apparatuses 200 and 400, and may output signals based on the sensing result. For example, the second sensor 322 may detect the sensing target 240 of the second display apparatus 200. The third sensor 323 and the fourth sensor 324 may independently detect the sensing target 440 of the fourth display apparatus 400, and may independently output the electrical signal based on the sensing result. In this case, the third display apparatus 300 may display the image 96c corresponding to the position of the third display apparatus 300 in the same manner as described above. If necessary, the second display apparatus 200 may also display the image 96b corresponding to the position of the second display apparatus 100 on the basis of the sensing result of the third display apparatus 300, the decision result of the relative position, and/or the decision result to be displayed.

Likewise, at least one 421 of the sensing portions 421 to 424 of the fourth display apparatus 300 may also output the electrical signal, and may display the image 96d corresponding to the position of the fourth display apparatus 300 in the same manner as described above.

In accordance with an example embodiment, the display apparatuses 100 to 400 may determine the relative positions of the respective display apparatuses 100 to 400 using the sensing results of the sensing portions 121˜124, 221˜224, 321˜324, and 421˜424 of the display apparatuses 100 to 400, or using the sensing result of at least one sensor 121˜124, 221˜224, 321˜324, and 421˜424 of the other display apparatuses 100 to 400, and may then determine the images to be displayed on the respective display apparatuses 100 to 400 using the determined relative positions. In other words, the processors of the display apparatuses 100 to 400 may directly determine the relative positions of the display apparatuses 100 to 400 and the images to be displayed on the display apparatuses 100 to 400.

In accordance with an example embodiment, the sensing results of the sensing portions 121˜124, 221˜224, 321˜324, and 421˜424 of the display apparatuses 100 to 400 may be transferred to at least one (e.g., the first display apparatus 100) of the display apparatuses 100 to 400. In this case, the first display apparatus 100 may determine the relative positions of the display apparatuses 100 to 400 and at least one of the images to be displayed on the respective display apparatuses 100 to 400, and may transmit the determined result to the corresponding display apparatus 200 to 400 or may display a predetermined image 96a according to the determined result. That is, one or at least two of the display apparatuses 100 to 400 may be configured to perform the function of the above-mentioned control device 900. If the at least two display apparatuses perform the function of the above-mentioned control device 900, the respective functions of the above-mentioned processors 160 and 260 may be processed in a distribution manner obtained by the processors of two or more display apparatuses.

In accordance with an example embodiment, the sensing results of the sensing portions 121˜124, 221˜224, 321˜324, and 421˜424 of the respective display apparatuses 100 to 400 may be transmitted to the control device 900 that is provided independently from the respective display apparatuses 100 to 400 and directly or indirectly communicates with the respective display apparatuses 100 to 400. The control device 900 may determine the relative position of each display apparatus 100 to 400 and at least one of the images to be displayed on the respective display apparatuses 100 to 400 on the basis of the sensing results of the sensing portions 121˜124, 221˜224, 321˜324, and 421˜424, and may also control the display apparatuses 100 to 400 by transmitting the determined results to the respective display apparatuses 100 to 400.

Although FIGS. 19A to 19C illustrate examples for use in four display apparatuses 100 to 400, the present disclosure is not limited thereto, and the number of display apparatuses 100 to 400 may be 3 or 5, or any other number.

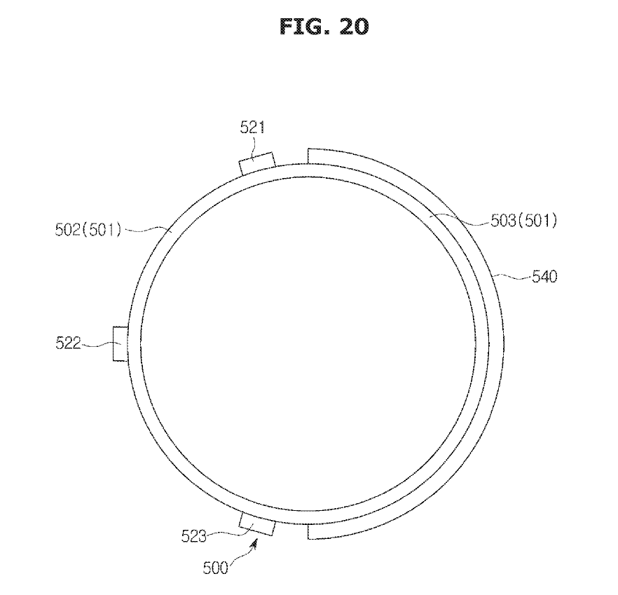

FIG. 20 is a view illustrating a display apparatus according to an example embodiment.

Referring to FIG. 20, the display apparatus 500 may be a circular or oval shape. In this case, the display apparatus 500 may include a circular housing 501, a circular display 510 mounted to the circular housing 501, at least one sensor 521, 522, and 523 formed in a first portion 502 of the circular housing 501, and at least one sensing target 540 formed in a second portion 503 of the circular housing 501. In this case, the first portion 502 and the second portion 503 may be mounted to the circular housing 501 in a manner that the first portion 502 does not overlap the second portion 503.

The display 510 may be implemented using various kinds of display panels in the same manner as described above, and may be implemented using a curved display or a bendable display as necessary.

At least one sensor 521, 522, and 523 may be configured to detect the sensing target of another display apparatus. As described above, the at least one sensor may be implemented using the inductance sensor 1221, the illumination sensor 1223, and the color sensor 1420. In addition, the at least one sensor 521, 522, and 523 may also be implemented using a light source and a light sensor configured to detect light reflected from the sensing target 540. In this case, the other display apparatus may be a circular display apparatus as shown in FIG. 20, or may be a rectangular- or square-shaped display apparatus 100 to 400 as shown in FIGS. 1 to 19.

The sensing target 540 may be detected by the sensor of the other display apparatus. For example, the sensing target 540 may be implemented either using light emitting elements 1420 and 1430 capable of emitting various brightness of light and/or various wavelengths of light, or using the sensing target material 1440. In the same manner as described above, the other display apparatus may be a circular display apparatus as shown in FIG. 20, or may be a rectangular- or square-shaped display apparatus 100 to 400 as shown in FIGS. 1 to 19.

Although the display apparatus 500 is formed in a circular or oval shape as shown in FIG. 20, images to be displayed on the display 510 of the display apparatus 500 of the display apparatus 500 may be determined either using the same method as in FIGS. 1 to 19 or using a partially modified method. In this case, the images to be displayed may be the entirety of one image or may be some parts of one image.

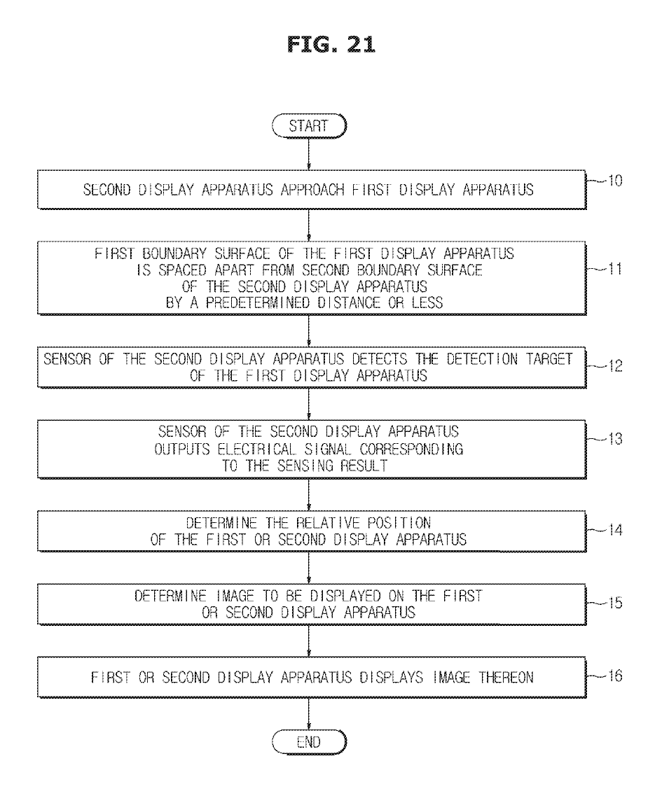

A method for controlling the display apparatus will hereinafter be described with reference to FIG. 21.

FIG. 21 is a flowchart illustrating a method for controlling the display apparatus. FIG. 21 is a flowchart illustrating a method for controlling two display apparatuses (i.e., the first display apparatus and the second display apparatus).

Referring to FIG. 21, the second display apparatus can approach the first display apparatus (10), such that the first boundary surface of the first display apparatus may be spaced apart from the second boundary surface of the second display apparatus by a predetermined distance or less (11). In this case, the first boundary surface of the first display apparatus may be in contact with the second boundary surface of the second display apparatus.

The first display apparatus and the second display apparatus may start operation before the second display apparatus moves close to the first display apparatus.

If the first boundary surface of the first display apparatus and the second boundary surface of the second display apparatus are in contact with each other or in close proximity to each other, at least one sensor mounted to the second boundary surface of the second display apparatus may detect the sensing target formed at the first boundary surface of the first display apparatus (12).

At least one sensor may be implemented using the inductance sensor, the illumination sensor, and the color sensor according to an example embodiment. In addition, at least one sensor may also be implemented using a light source and a light sensor configured to detect light reflected from the sensing target.

In accordance with an example embodiment, the sensing target may be implemented either using a conductor corresponding to the inductance sensor, a light emitting element corresponding to the illumination sensor, a light emitting element corresponding to the color sensor, or using the sensing target material.

The sensor of the second display apparatus may detect the sensing target, and may output the electrical signal corresponding to the sensing result (13).

If the sensor outputs an electrical signal, the relative position of at least one of the first display apparatus and the second display apparatus can be determined on the basis of the electrical signal (14).

In this case, the relative position may be determined by the first display apparatus or the second display apparatus, or may be determined by the control device provided independently from the first or second display apparatus.

If the relative position of at least one of the first display apparatus and the second display apparatus is determined, the images to be displayed on at least one of the first display apparatus and the second display apparatus can be determined on the basis of the relative position of at least one of the first display apparatus and the second display apparatus (15).

Determination of the images to be displayed may be performed by the first display apparatus or by the second display apparatus. Alternatively, determination of the images to be displayed may also be performed by the control device provided independently from the first or second display apparatus. In accordance with an example embodiment, images to be displayed by the device having determined the relative position may be decided, or images to be displayed on the other device having not determined the relative position may be decided. The images to be displayed on at least one of the first display apparatus and the second display apparatus may be all or some of one image. In this case, the first display apparatus may display a first portion of a single image, and the second display apparatus may display a second portion of the single image. The second portion may be different from the first portion.

If the image to be displayed on at least one of the first display apparatus and the second display apparatus is decided, at least one of the first display apparatus and the second display apparatus may display the decided image (16).

Although the above-mentioned description has disclosed one example of the method for controlling the above-mentioned display apparatuses according to an example embodiment including two display apparatuses, the scope or spirit of the above-mentioned method for controlling the display apparatuses is not limited to an example embodiment that includes two display apparatuses. The above-mentioned method for controlling the display apparatuses may be equally applied to or be partially modified into the other case in which three or more display apparatuses are used without departing from the scope of the present disclosure.

As is apparent from the above description, the display apparatus, the multi-display system, and the method for controlling the display apparatus according to example embodiments can determine a relative position of each display apparatus when a plurality of display apparatuses is combined to display one or more images, and can properly display some parts of the image corresponding to the determined position.

The display apparatus, the multi-display system, and the method for controlling the display apparatus according to example embodiments can allow the respective displays to properly display images corresponding to the respective positions even when the plurality of displays is typically or atypically arranged.

The display apparatus, the multi-display system, and the method for controlling the display apparatus according to example embodiments can arrange a plurality of displays in various ways such that the plurality of displays can be arranged according to a user-desired scheme.

Although example embodiments have been shown and described, it would be appreciated by those skilled in the art that changes may be made in the example embodiments without departing from the principles and spirit of the invention, the scope of which is defined in the claims and their equivalents.

What is claimed is:

1. A display apparatus comprising:
a housing;
at least one sensor mounted to a first boundary surface of the housing; and
a display configured to display an image corresponding to a position of the display apparatus determined based on an electrical signal generated from the at least one sensor.

2. The display apparatus according to claim 1, further comprising:
a sensing target formed at a second boundary surface facing the first boundary surface.

3. The display apparatus according to claim 2, wherein the sensing target is configured to be detected by at least one sensor of a second display apparatus.

4. The display apparatus according to claim 3, further comprising:
a communicator configured to receive a sensing result obtained by the at least one sensor of the second display apparatus,
wherein the display is configured to display an image corresponding to the position of the display apparatus determined based on the sensing result that is received.

5. The display apparatus according to claim 2, wherein the sensing target extends from a peripheral part of a first end of the second boundary surface to a peripheral part of a second end of the second boundary surface, and is formed at the second boundary surface.

6. The display apparatus according to claim 5, wherein the sensing target is formed at the second boundary surface in a predetermined pattern extending from a peripheral part of the first end of the second boundary surface to a peripheral part of the second end of the second boundary surface.

7. The display apparatus according to claim 6, wherein:
the sensing target comprises a metal material,
wherein the metal material is formed at the second boundary surface and is gradually reduced in width from a peripheral part of the first end of the second boundary surface to a peripheral part of the second end of the second boundary surface.

8. The display apparatus according to claim 6, wherein:
the sensing target comprises a plurality of light sources,
wherein a first light source, which is relatively adjacent to the peripheral part of the first end of the second boundary surface, from among the plurality of light sources, emits brighter light than a second light source, which is relatively adjacent to the peripheral part of the second end of the second boundary surface.

9. The display apparatus according to claim 8, wherein:
the sensing target comprises a plurality of light sources,
wherein each of the plurality of light sources emit a different brightness of light, and the plurality of light sources are sequentially arranged, according to brightness, in a range from the peripheral part of the first end of the second boundary surface to the peripheral part of the second end of the second boundary surface.

10. The display apparatus according to claim 6, wherein the sensing target comprises a plurality of light sources, and each of the plurality of light sources emit a different wavelength of light.

11. The display apparatus according to claim 1, wherein the at least one sensor is configured to detect a sensing target mounted to a second display apparatus.

12. The display apparatus according to claim 11, further comprising:
a processor configured to determine a relative position between the second display apparatus and the display apparatus based on an electrical signal generated from the at least one sensor.

13. The display apparatus according to claim 12, wherein the processor is further configured to determine a relative position between the second display apparatus and the display apparatus using a position of the at least one sensor that generated the electrical signal.

14. The display apparatus according to claim 12, wherein the processor is further configured to determine a relative position between the second display apparatus and the display apparatus based on a magnitude of the electrical signal generated from the at least one sensor.

15. The display apparatus according to claim 12, wherein:
the processor is configured to determine an image to be displayed on the display based on a relative position of the display apparatus, control the relative position of the display apparatus to be transmitted to the second display apparatus, or determine an image to be displayed on the second display apparatus based on a relative position of the display apparatus, and transmit the image that is determined to be displayed on the second display apparatus to the second display apparatus.

16. The display apparatus according to claim 1, wherein the at least one sensor comprises at least one from among an inductance sensor, an illumination sensor, and a color sensor.

17. The display apparatus according to claim 1, wherein the at least one sensor is mounted to at least one from among a first end and a second end of the first boundary surface.

18. The display apparatus according to claim 1, wherein the at least one sensor is mounted to a boundary surface orthogonal to the first boundary surface.

19. A multi-display system comprising:
a first display apparatus comprising:
a first housing; and
a sensing target formed at a first boundary surface of the first housing;
a second display apparatus comprising:
a second housing;
a second boundary surface formed in the second housing and mountable in contact with the first boundary surface; and
a sensor mounted to the second boundary surface that outputs an electrical signal according to a sensing result of a first sensing target; and
a display control device configured to:
determine a relative position between the first display apparatus and the second display apparatus based on the electrical signal; and
determine an image to be displayed on at least one from among the first display apparatus and the second display apparatus according to the relative position that is determined.

20. A method for controlling a plurality of display apparatuses, the method comprising:
determining whether a first boundary surface of a first display apparatus and a second boundary surface of a second display apparatus approach each other;
detecting, by a sensor mounted to the second boundary surface of the second display apparatus, a sensing target formed at the first boundary surface of the first display apparatus;
outputting, by the sensor, an electrical signal corresponding to a sensing result of the sensing target;
determining, by at least one from among the first display apparatus, the second display apparatus, and a control device connected to at least one of the first display apparatus and the second display apparatus, a relative position of at least one from among the first display apparatus and the second display apparatus based on the electrical signal; and
determining, by at least one from among the first display apparatus, the second display apparatus, and a control device connected to at least one of the first display apparatus and the second display apparatus, an image to be displayed on at least one from among the first display apparatus and the second display apparatus according to a relative position between the first display apparatus and the second display apparatus.
